(19) United States
(12) Patent Application Publication
(10) Pub. No.: US 2004/0163604 A1
(43) Pub. Date: Aug. 26, 2004

(54) Animal litter system

(76) Inventors: Robert C. Kirk, Salem, OR (US); Stacey R. Kirk, Salem, OR (US)

Correspondence Address: ROBERT C. KIRK, 5320 STATE STREET, SALEM, OR, 97301, US

(21) Appl. No.: 10/742,209

(22) Filed: Dec. 22, 2003

Related U.S. Application Data
(60) Provisional application No. 60/440,799, filed on Jan. 15, 2003.

(51) Int. Cl. A01K 29/00

(52) U.S. Cl. 119/166

(57) ABSTRACT

A cat litter box of the pass through type which includes a tray on which the litter is deposited with the tray having openings in the base for the passage of liquid wastes into a sump or other means for the collection of liquid waste separate from the litter, a convenient means for releasing the collected liquid and means for reducing the release of odors from the collected liquids and residues which cling to the litter. The box is used with litter of a granular type that sheds liquids, and mitigates odor from residues and liquids which have been shed.

### BACKGROUND OF THE INVENTION

The present invention concerns litter and litter boxes of the type used in the home for the reception of liquid and solid waste matter commonly used with pets such as cats, dogs, or small animals.

In wide use are receptacles filled with particulate which absorbs liquid waste and suspends solid waste matter. Regular cleaning of such receptacles is an arduous, disagreeable, costly and wasteful task in that the portion of the litter saturated with liquid must be removed frequently and the receptacle cleaned and recharged with fresh, absorbent material.

Also common and in wide use are absorbent litters with odor treating components, acting both on the chemical and biological or bacterial components of litter box odor, or sprays or powders which can be added to litter.

U.S. Pat. No. 6,287,550 discloses a litter system with odor reducing agents, anti-bacterial agents and perfumes to control and reduce litter odor.

U.S. Pat. No. 5,970,915 discloses a litter box preparation using a dry silica gel granular litter with the application of a disinfectant to the litter box to reduce litter odor.

Pass-through litter systems are also described. These systems use non-absorbent litter which sheds liquids and grids or filters which retain the litter and collect the liquid waste for disposal.

U.S. Pat. No. 4,444,148 discloses a litter box using particulate coated with wax to inhibit absorbency to permit liquid waste to pass downwardly through a foraminous tray supporting the layer of granular material into a collection tray which may be provided with absorbent sheet material such as newsprint which eventually must be removed when saturated during a cleaning operation.

U.S. Pat. No. 2,971,493 discloses a litter box comprised of inner and outer boxes with the inner box provided with a layer of non-absorbent material while the lower box serves to collect liquid waste.

U.S. Pat. No. 5,193,488 discloses a litter system which has the urine go through a nonabsorbent material in a top tray and then through a pervious bottom of said top tray, thence dropping on a suspended porous aeration tablet or pad.

U.S. Pat. No. 5,184,574 discloses a litter box using solid litter and a secondary collection sump to collect liquid waste. Non absorbent plastic is suggested as the litter material. The present invention is drawn primarily to an improvement over this litter box system.

U.S. Pat. No. 6,408,790 discloses a litter box generally similar to the litter box disclosed in U.S. Pat. No. 5,184,574, using non-absorbent litter, except that, instead of a valve, placed within the base is a removable reservoir drawer for the liquid waste that is positioned within the base, so as to receive the liquid waste flowing through the drain pan hole, and the reservoir drawer is removed and re-positioned through a drawer opening in the base perimeter wall.

A problem exists in known litter boxes using absorbent litter in that the litter must absorb all the liquid. Litter quickly becomes saturated. To avoid malodor, saturated particulate must be disposed of They present a difficult task in periodical treating in that a mass of litter must be removed after only a short time and replaced with fresh, absorbent material.

A problem exists in the use of odor fighting components embedded in or added to litters which are intended to absorb liquid waste in conventional litter systems, in that the odor fighting compounds must still treat all of the liquid waste. This reduces the capacity of litter to absorb wastes, increases the cost, and limits the period of effective control of odors, even with large amounts and high concentrations of odor fighting agents.

A problem exists in pass though litter systems using non-absorbent litter and secondary collection that still result in a collection of odorous urine in residues that are unavoidably retained in the litter. Litter must be rinsed to eliminate the residues and even rinsing can fail to remove the accumulated effect of odorous residues.

Unlike ordinary absorbent litter which normally requires separation of used from unused litter, litter made from silica gel is intended to be replaced all at one time. This reduces the effort associated with daily maintenance, but the period of effective use in prior systems that use silica gel type litters is limited by the need for the litter to absorb all the liquid. Life is further reduced when the silica litter in areas of concentrated use becomes saturated. Unabsorbed liquids in these areas form puddles that will generate strong odors.

### SUMMARY OF THE PRESENT INVENTION

The present invention provides a solution to the previously described problems by providing a portable cat litter box including a suspended litter tray and pass through means for liquid waste with convenient means for periodically discharging such waste.

The improvement of the present invention is in further providing litter in said litter box which is designed to shed the major portion of liquid waste, and to additionally mitigate the odors produced by residues which are unavoidably retained in the litter and block the release of vapors from collected liquids. The benefit of such a litter compound is particularly noted when used with a pass through litter system.

In this application, odor fighting agents and absorbent capacity are required to act only on the small amount of liquid waste which coats or is trapped between the particles. The period of effective odor control and the cost of maintaining the system is extended compared to other systems because most of the liquid is separated from the litter and removed without removing the litter.

A litter box according to the present invention includes a tray having a perforate bottom on which a quantity of particulate material is supported with the particulate preferably being of fortified, synthetic material such as granular silica gel, non-absorbent material, such as plastic, embedded or coated with odor fighting agents, or other materials which initially shed liquids but ultimately absorb and/or mitigate the odor-producing qualities of liquid residues.

Such particulate material serves to receive solid waste as well as permit the flow of liquid waste downward through the perforate bottom into a collection site in a base supporting the tray. The particulate reduces vaporization of the collected liquid and serves also as an odor barrier. It is also helpful and effective in encapsulating fecal material so as to make it more accessible to a scoop for removal.

In the preferred embodiment, the particulate is generally spheroid in configuration. The granules preferably are of a uniform size, having a diameter in the range of 3-5 millimeters or such diameter as can be effectively retained by the openings in the perforate bottom. The uniform size and spheroid shape serves to facilitate the flow of liquids through the particles and to minimize the intersections of particles that could dam or trap liquids.

The preferred granules are non-absorbent over the short term (i.e. one minute) but absorb residues which adhere to the particles through surface tension or are trapped between particles over the longer term (i.e.: one hour). Odor neutralizing agents or compounds and anti-bacterial agents may be embedded in or coated upon the granules to further reduce malodor. In order to be retained by the grid and to make periodic cleaning easier, granules in the preferred embodiment will also retain their size and shape following prolonged exposure to liquids.

Though any number of materials may be used, in the preferred embodiment, granular silica gel, byproducts from the recycling of paper or cardboard, wood, or other organic materials, which are formed into particles generally spheroid in configuration are preferred.

In silica gel litter, reducing the size of the pores controls absorption rates. In other materials, absorption rates are controlled by either withholding the surfactants which are often added to increase the absorption rate or by applying hydrophobic materials which reduce absorption rates, by providing surface finishes that retard absorption, etc.

The materials are processed using extruders, pin mills, or pelletizers to produce the spherical shape, compression, and surface finishes which minimize short-term absorption and retain particulate integrity. Meshes or screens are used to produce the uniform size.

Granules may also be made of naturally odor fighting materials which shed liquids but absorb malodors and are dissolved into the liquid waste itself An example of such a material is potassium aluminum sulfate in crystallized form. Preferred crystals will dissolve slowly and resist binding to one another even after exposure to liquids.

Granules may also be made from solid, non-absorbent material such as plastic that has been coated with an odor treating material.

Preferred materials of the invention are sufficiently absorbent to accept odor-neutralizing agents and dispense them into urine from domestic animals. The addition of disinfectant and/or odor reducing agents creates a fortified litter. Useful disinfectants such as commonly found and available under the trade designation LYSOL® may be used. Odor reducing agents of any number of types may be used, including sodium bicarbonate solution or other bicarbonate solutions. A number of other odor-neutralizing and disinfecting agents may be used, including those disclosed in U.S. Pat. No. 4,898,727 to Osada et al., U.S. Pat. No. 6,495,097 to Streit et al., and U.S. Pat. No. 6,253,710 to Ward et al. Other compounds used to fortify the litter may include fungicides and other water-soluble organic agents such as undecylenic acid as disclosed in U.S. Pat. No. 4,517,919 to Benjamin et al. Perfumes may also be added to the litter. The dry material may be brought up to a high liquid weight, the liquid comprising a solution of disinfectant and/or odor reducing agent, and still retain a strong, solid form.

In the preferred embodiment of the invention the litter is comprised of dry material as described above. The litter is placed in a litter box tray suspended above a collection site.

In use, the litter sheds most of the liquid waste but may exchange some of the urine or moisture with some of the embedded disinfectant and/or odor reducing agent as the urine flows past the litter, through osmosis. Residues trapped between particles are especially strongly treated with the odor fighting agents. The result is that odors produced by urine and liquid fecal material exposed to the litter are reduced or eliminated for long periods of time.

As liquids such as urine wash through the fortified litter, small amounts of odor neutralizer and/or antibacterial agent are carried with the urine or other liquid. The further benefit of the invention is that any liquid collected in the sump or receiver of the system is treated with an amount of odor neutralizer and/or antibacterial agent reducing the odors associated with the litter box and the eventual discharge or clean up of the reservoir.

Alternatively, the litter may consist entirely of odor mitigating materials such as silica gel or potassium aluminum sulfate. Silica gel suitable for use in this system will absorb liquids slowly in order to maximize the flow of liquid into the collection means but trap liquid residuals and odorous vapors in pores. Urine flows through potassium aluminum sulfate crystals. The crystals dissolve so slowly in the liquid that they are useful for long periods of time. Liquid residues and malodors are absorbed into the crystalline structure and the liquid forms a solution after passing through the crystals that has less odor than liquid waste which has not been exposed to the crystals.

Important objectives of the invention include the provision of a readily cleaned cat litter box that separates liquid from litter and provides a convenient means for eliminating the separated liquid, and a litter adapted to use in the litter box by shedding liquids and mitigating the odors from residues and the collected liquids. By separating wastes from litter and controlling the odor from residues, odor control is improved, liquids are easier to eliminate, and litter will last longer thus reducing cost and waste.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a front elevational view of the present litter box.

FIG. 2 is a vertical sectional view taken along line 2-2 of FIG. 1.

FIG. 3 is an enlarged fragmentary view of the portion of FIG. 2 encircled at 3.

FIG. 4 is a front elevational view of the cat litter box temporarily in place on a toilet bowl for cleaning purposes.

FIG. 5 is a fragmentary elevation view of a modified cat litter box wherein a litter-receiving tray is of reduced height.

FIG. 6 is an enlarged elevational view of a silica gel pellet for the present litter box.

FIG. 7 is a perspective view of an alternative embodiment of the base portion of the present invention with handle for controlling the valve and illustrating an alternative handhold.

FIG. 8 is a partially schematic view taken along line 8-8 of FIG. 7.

FIG. 9 is a partially schematic view taken along line 9-9 of FIG. 7.

FIG. 10 is a sectional exploded view taken along line 9-9 of FIG. 7, showing the structure of an alternative type of valve suitable for use in an embodiment of the invention.

FIG. 11 is a view of a portion of a preferred embodiment of the perforate bottom of the tray forming a part of the invention, taken in the direction indicated by line 11-11.

### DETAILED DESCRIPTION OF THE PREFERRED EMBODIMENTS

With continuing attention to the drawings wherein applied reference numerals indicate parts similarly hereinafter identified, the reference numeral 1 indicates generally a base of the present litter box.

The base includes a wall 2 about its perimeter which includes front and rear walls and 4 along with end walls 5 and 6. The walls comprising wall 2 each merge downwardly with a respective one of inwardly inclined bottom walls 7, 8, 9 and 10 which provide a convenient surface for grasping and carrying of the litter box.

A support wall or skirt 11 is integral with the above-mentioned inclined bottom walls and provides a stable support for base 1. Support wall 11 terminates downwardly in a continuous lower edge 11A.

A tray 12 of the present litter box is a walled structure with an outer wall 13. The tray 12 is supported in the base 1, within base wall 2, and serves to receive a layer of fortified particulate 16 on a perforate bottom wall 14. The tray terminates upwardly in a rim 15 having an inwardly turned continuous lip to prevent scattering of the particulate by the pet. Tray 12 is of a size as to seat within base wall 2 on the inclined walls of the base. If so desired the wall 2 of the base may be internally shouldered to support the tray in a spaced manner above the inclined bottom walls of the base. The tray bottom 14 is of perforate construction having a multitude of openings 14A of lesser size than the smallest dimension of the fortified particulate material for particulate retention.

A preferred litter particulate is a liquid-shedding pellet having a smooth exterior, fortified with odor controlling agents or other means to mitigate odors from residuals. Such particulates are preferably round or elliptical shape to avoid trapping liquids in the litter, as shown in FIG. 6, having a preferred size of 3-5 mm.

The preferred fortified litter is a robust pellet that may have odor controlling agents embedded in or coated upon the granules. The fortifying agent is preferably a mixture of odor neutralizing and antibacterial compounds. The fortifying agent may further include fungicides and perfumes.

The convergent walls 7, 8, 9, and 10 of the base terminate downwardly to support a valve body 17 defining a discharge passageway 18. Valve body 17 also defines a valve seat 20 which carries a rotatable member 21, shown as being of the plug type, having an opening 22 for communication with passageway 18. A seal at 23 may be an O-ring retained within a groove 24 extending about valve member 21. Other valve types may be utilized such as, for example, a ball valve or a slide valve.

A valve control rod 25 engages member 21 to impart rotational movement thereto. For this purpose control rod 25 is provided with an end 25A for inserted locked engagement with corresponding socket 26 in member 21. Control rod end 25A may have a flat surface for driving engagement with plug member 21. Rod 25 terminates outwardly to locate a handle 27 in a highly accessible manner outwardly adjacent support wall 11 and front wall 3. To facilitate assembly and retention of the valve means above described, control rod 25 may be apertured to receive a cotter pin 28 to prevent undesired axial movement of the rod. Handle 27 is preferably proximate to a floor surface F and includes an appendage 27A such as a wing or arm which, upon arcuate movement, as in the case of rotation of the handle 27, would come into contact with the floor surface F to prevent opening of the valve 17 and inadvertent waste discharge from the base. To prevent contact with the floor, a valve bottom wall 17A is offset upwardly from a plane containing wall edge 11A.

A modified litter box is disclosed in FIG. 5 wherein a tray at 30 is generally flat while a base wall 2′ is of adequate height to confine the litter against discharge. Prime reference numerals in FIG. 5 indicate parts corresponding to parts earlier identified with like base reference numerals.

In FIG. 4 the litter box 1 is shown in place for cleaning purposes as for example on a toilet bowl B to permit the base to be emptied of liquid waste via valve 17. It will be noted that the control handle 27 is easily accessible and can be rotated without interference when the base is so located.

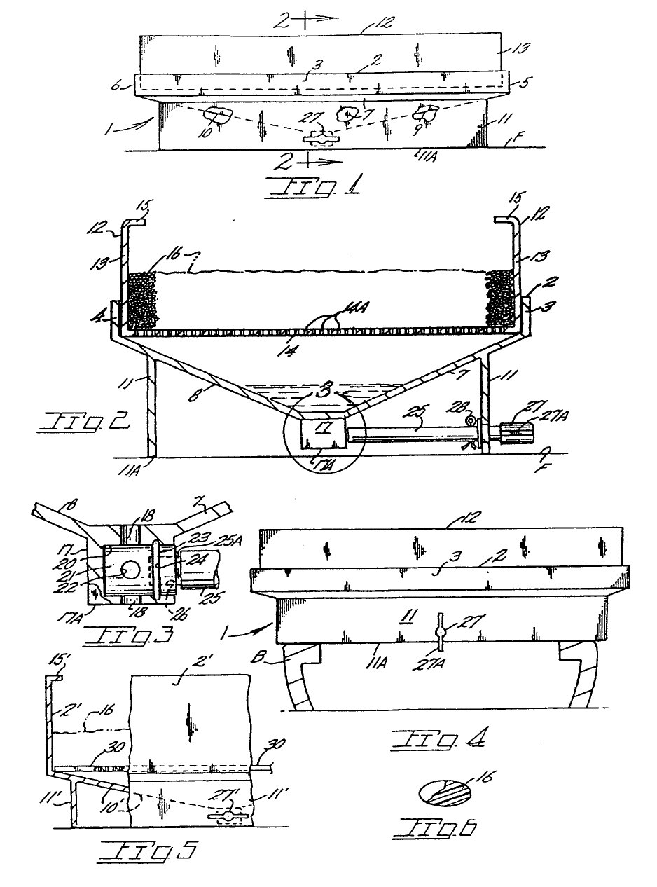

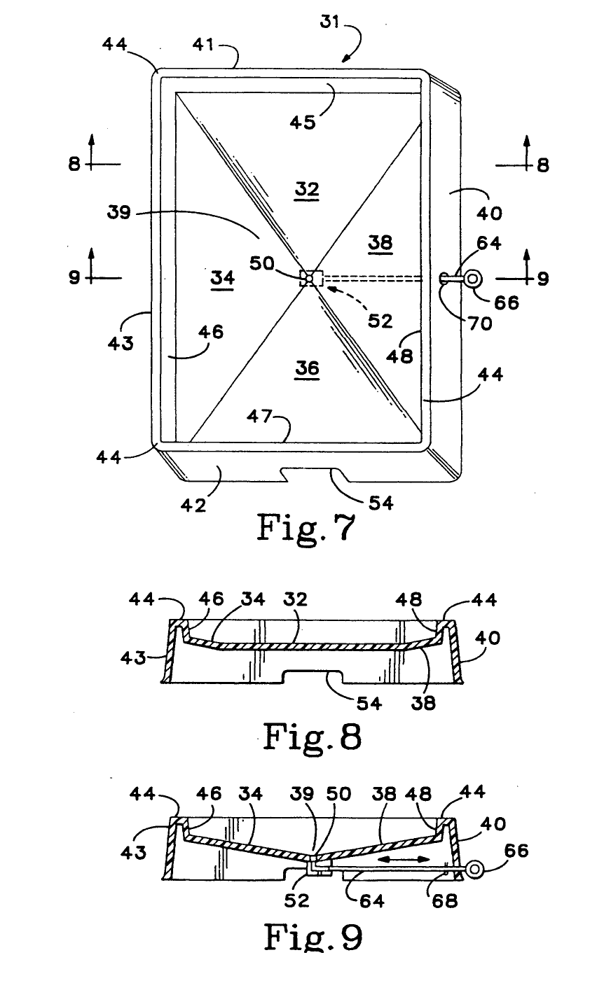

FIGS. 7 through 10 illustrate portions of another alternative embodiment of a base portion of a cat litter box arrangement according to the present invention. As best seen in FIG. 7, a base 31, which may be of molded plastic material, contains integral bottom walls 32, 34, 36 and 38 that slope downwardly toward one another defining a sump 39 in which an opening 50 is located. Base 31 further includes end walls 41 and 42, front wall 40 and rear wall 43. Walls 40, 41, 42, and 43 are interconnected with one another, extending upwardly and being interconnected with a generally horizontal continuous rim 44. The tray 12 (shown in FIGS. 1, 2, and 4) rests on the base 31 in the same way in which it rests on the base 1, with the inner walls 45, 46, 47, and 48 surrounding a lower portion of the tray 12 when it is in place. Walls 40, 41, 42, and 43 thus serve as support walls comparable to the support wall 11 shown in FIGS. 1, 2, and 4. Inner walls 45, 46, 47, and 48 are joined continuously with rim 44, extending downward therefrom nearly vertically, and at their bottom margins are joined with bottom walls 32, 34, 36, and 38 respectively. The bottom walls 32, 34, 36, and 38, defining the sump 39, slope much more gently toward the middle of the space defined by the walls 40, 41, 42, and 43.

It will be noted in FIGS. 7 and 8 that end walls 42 and 41 define handholds 54 to facilitate conveniently grasping, lifting, and carrying the base 31 with the tray 12 located thereon.

Opening 50, at the lowest point of the sump 39, is closed by a valve 52. When the perforate tray containing fortified particulate litter 16 is supported in place on the base 31 liquid waste deposited on the fortified particulate litter 16 disposed in the perforate tray is free to run off the surfaces of the particulate 16 and drain through the perforate bottom 14 of the tray 12 into the sump 39.

Release of liquid from the sump 39 is controlled by valve 52 which may be preferably manufactured separately from the base and adhesively attached thereto. The top surface 53 of valve 52 is preferably a flat surface suitable for attachment to a correspondingly flat bottom surface surrounding the opening 50 in the sump 39 of base 31. Valve 52 is attached to base 31 such that the upper opening 58 of valve 52 is properly aligned with the opening 50 of sump 39 in base 31.

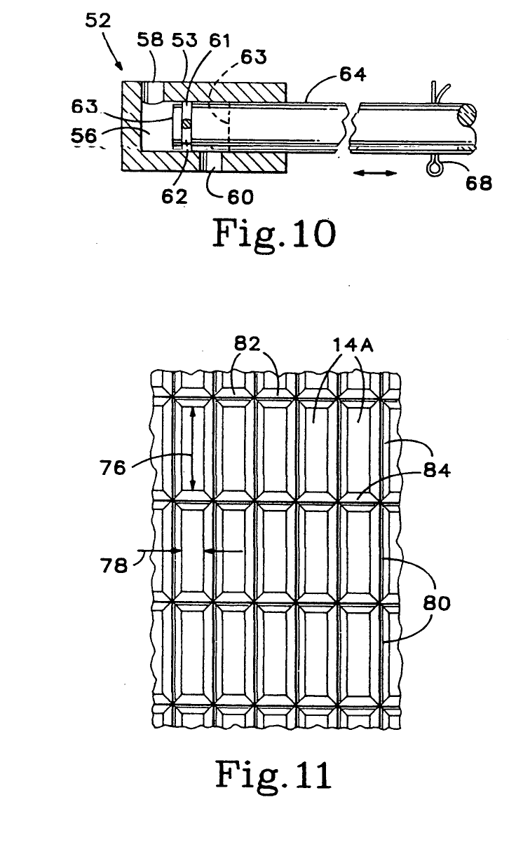

As best seen in FIG. 10, the valve 52 includes a valve body 56 defining an upper opening 58 and a drain 60. A valve piston has a front face 63. An O-ring 61, shown partially cut-away, is located in a groove 62 in the valve piston, and will prevent the passage of any liquid through the drain 60 when the valve is closed as shown in FIG. 10. When the valve is in the open position, the face 63 of the piston is in the position shown in broken line, and the O-ring is moved laterally in the valve body 56 so that communication between upper opening 58 and the drain opening 60 is unobstructed and any liquid contained in the sump 39 is released through opening 50, through upper opening 58 and thence downward out the drain opening 60. When the valve is closed the O-ring 61 forms a tight seal between upper opening 58 and drain opening 60 preventing any seepage of liquid through drain opening 60. When the valve 52 is open the O-ring 61 prevents seepage of liquid waste along the control rod or shaft 64 toward the control handle 66.

A handle 66 is provided for the operation of the valve and a retainer pin 68 prevents the groove 62 containing an O-ring from being inadvertently removed from the valve body 56. In a preferred embodiment the handle 66 is accessible to the operator at opening 70 in the front wall 40 of the base 31, allowing convenient “push-pull” operation of the valve 52. This arrangement also provides adequate vertical support for the control rod 64. When the base 31 is located on a toilet bowl the handle 66 is readily accessible for easy emptying and flush cleaning of the litter box.

As shown in FIG. 11, the tray bottom 14 of the perforate tray 12 of the present invention may be molded to define regularly spaced openings 14A of a size small enough to prevent the passage of the semi-absorbent litter particulate pellets 16 through the openings. Thus, the bottom 14 preferably includes a grid defining openings 14A each having a length 76 of about 0.4 inch and a width 78 of about 0.1 inch. Openings 14A of this size will retain all particles of the litter material 16 having a diameter greater than the width 78 of the grid opening such as particle 16 shown enlarged in FIG. 6.

It will also be noted that bars 80, 82 defining grid openings have knife edges 84 which minimize horizontal areas upon which liquid can collect, thus insuring that liquid deposited on the fortified particulate litter 16 will drain promptly into the sump 39 below.

The terms and expressions which have been employed in the foregoing 110 specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A pet litter system, comprising:
(a) a tray, including an upstanding wall and perforate bottom means for supporting a quantity of litter, said bottom means defining a plurality of openings through which liquid waste is free to pass while litter is retained;
(b) a base supporting said tray, said base including an upstanding support wall with means for supporting said litter box above a collection means intended for the capture of liquids which pass through the litter and the tray:
(c) collection means, preferably located within said base, for collecting all of said liquid waste which passes through said openings in said bottom means, said collection means having a convenient method for eliminating the collected waste;
(d) Litter being comprised of materials which shed liquids but inhibit the odor which may be produced from residues or collected liquids.

2. Litter made suitable for use in the system claimed in claim 1 by inhibiting the rate of absorption, said litter being made from fibers or other similar materials, or silica gel, compressed or extruded into robust pellets or granules. Said litter may also be fortified by coating the litter with odor controlling materials or embedding odor coating materials into said litter.

3. Litter made suitable for use in the system claimed in claim 1 by choosing crystals of suitable size and material. Potassium aluminum sulfate crystals with dimensions slightly larger than the openings in the base of the trays described in claim 1 are an example.

4. Litter made suitable for use in the system claimed in claim 1 by coating unabsorbent material such as plastic with odor controlling materials.
